(19) United States
(12) Patent Application Publication
(10) Pub. No.: US 2024/0271909 A1
(43) Pub. Date: Aug. 15, 2024

(54) LINE-OF-SIGHT PAYLOAD DELIVERY SYSTEM

(71) Applicant: Omer BAR LEV, Kokhav-Yair (IL)

(72) Inventors: Omer BAR LEV, Kokhav-Yair (IL); Ran CARMELI, Kfar Sirkin (IL)

(73) Assignee: Omer BAR LEV, Kokhav-Yair (IL)

(21) Appl. No.: 18/687,320

(22) PCT Filed: Aug. 29, 2022
(86) PCT No.: PCT/IL2022/050943

§ 371 Date: Feb. 28, 2024

(30) Foreign Application Priority Data
Aug. 29, 2021 (IL) 285981

(51) Int. Cl. F41G 3/06; B64D 7/00; B64U 10/25; B64U 70/70; B64U 101/18; F41G 3/22

(52) U.S. Cl. CPC F41G 3/065; B64D 7/00; B64U 10/25; B64U 70/70; F41G 3/22; B64U 2101/18

(57) ABSTRACT

A line of sight (LOS) delivery system. The system includes a carrier device having a first collimated light source for targeting an object, a distance meter; and a second collimated light source for outputting a beam substantially parallel to a targeting beam of the first collimated light source. The system further includes an aerial vehicle mounted on the carrier device having a camera for acquiring an image including the object targeted by the first collimated light source, an optical assembly for reflecting the second collimated light source into the image to form a light dot on the object and a processing unit for controlling a flight of the aerial vehicle based on a location of the light dot with respect to the object in said image.

### RELATED APPLICATION/S

This application claims the benefit of priority of Israel Patent Application No. 285981 filed on Aug. 29, 2021, the contents of which are incorporated herein by reference in their entirety.

### BACKGROUND

The present invention relates to a system for delivering a payload to a line-of-sight target. Embodiments of the present invention relate to a drone delivery system that employs a line-of-sight targeting system capable of correcting for drone-targeting misalignments.

A delivery drone is an unmanned aerial vehicle (UAV) used to transport packages including medical supplies, food and other goods. Delivery drones are typically autonomous and rely on GPS to navigate to a target site. While such drones can be used for safe delivery of packages beyond visual line of sight (BVLOS) disruption in GPS signal which can originate from satellite malfunction or solar flares can render such delivery drones useless.

Line-of-sight (LOS) delivery drones are typically not autonomous and are navigated by an operator to a target site. While LOS drones lack the capability to deliver packages beyond LOS, use thereof over short distances can augment or replace BVLOS drones.

One disadvantage of LOS drones is the need for an operator to navigate the drone to the target site. Such a requirement can pose major limitations on LOS delivery since the flight path and delivery precision can be negatively affected by the skill level of the operator and environmental conditions.

While laser targeting systems can be used for automated delivery of drones, such systems must rely on careful alignment between the drone launcher and the targeting system mounted on the launch carrier.

There thus a need for an LOS drone delivery system that can be used to deliver payloads such as packages without a need for a human flight path operator and while correcting for misalignment between the drone launch path and the targeting system mounted on the launch carrier.

### SUMMARY

According to one aspect of the present invention there is provided a line of sight (LOS) delivery system comprising a carrier device including a first collimated light source for targeting an object; a distance meter; and a second collimated light source for outputting a beam substantially parallel to a targeting beam of the first collimated light source; and an aerial vehicle mounted on the carrier device, the aerial vehicle including: a camera for acquiring an image including the object targeted by the first collimated light source; an optical assembly for reflecting the second collimated light source into the image to form a light dot on the object; and a processing unit for controlling a flight of the aerial vehicle based on a location of the light dot with respect to the object in the image.

According to embodiments of the present invention the carrier includes a guide rail for launching the aerial vehicle.

According to embodiments of the present invention the aerial vehicle is a fixed wing vehicle.

According to embodiments of the present invention the fixed wing vehicle deploys a wing following launching from the carrier.

According to embodiments of the present invention a maximum deviation from parallel between the first collimated light source and the second collimated light source is derived from the distance and accuracy required and can be about 0.1 milliradians or less.

According to embodiments of the present invention the processing unit establishes a flight path for the aerial vehicle based on a distance to object and the environment.

According to embodiments of the present invention the aerial vehicle includes a payload.

According to embodiments of the present invention the payload is a package.

According to embodiments of the present invention the payload is a warhead.

According to another aspect of the present invention there is provided a method of line of sight (LOS) delivery of a payload comprising targeting an object using a first collimated light beam; determining a distance to the target; and outputting a second collimated light beam substantially parallel to the first collimated light source; and launching an aerial vehicle, the aerial vehicle including: a camera for acquiring an image including the object targeted by the first collimated light beam; optics for reflecting the second collimated light beam into the image to form a light dot on the object; and a processing unit for controlling a flight of the aerial vehicle based on a location of the light dot with respect to the object in the image; navigating the aerial vehicle using the processing unit thereby delivering the payload to the target.

According to embodiments of the present invention the method further comprises repeating steps (a)-(d) to a second object.

According to embodiments of the present invention the aerial vehicle is launched from a carrier including a guide rail.

According to embodiments of the present invention the aerial vehicle is a fixed wing vehicle.

According to embodiments of the present invention the fixed wing vehicle deploys a wing following launching from the carrier.

According to embodiments of the present invention a maximum deviation from parallel between the first collimated light beam and the second collimated light beam is derived from the distance and accuracy required and can be about 0.1 milliradians or less.

According to embodiments of the present invention the processing unit establishes a flight path for the aerial vehicle based on the distance to object and the environment.

According to embodiments of the present invention the aerial vehicle includes a payload.

According to embodiments of the present invention the payload is a package.

According to embodiments of the present invention the payload is a warhead.

According to another aspect of the present invention there is provided an aerial vehicle (e.g., fixed wing or lift rotor drone) for delivering a payload, the aerial vehicle comprising a body attached to a lift system, the body including a camera for acquiring an image and an optical assembly for reflecting a collimated light beam provided from a collimated light source positioned outside the body into the image to form a light dot on the image; and a processing unit for controlling a flight of the aerial vehicle based on a location of the light dot on said image.

According to embodiments of the present invention the lift system includes fixed wings.

According to embodiments of the present invention the lift system includes lift rotors.

According to embodiments of the present invention the optical assembly includes at least one prism and a mirror.

According to embodiments of the present invention the at least one prism is a Penta prism.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a processing unit using any suitable operating system. In any case, selected steps of the system of the invention could be described as being performed by a data processor, such as a computing platform for executing a plurality of instructions.

### BRIEF DESCRIPTION OF THE SEVERAL VIEW OF THE DRAWING(S)

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 illustrates the present system with the aerial vehicle mounted on a carrier device fitted with a targeting assembly.

FIG. 2 illustrates the present system without the aerial vehicle showing the targeting components of the carrier.

FIGS. 3-4 illustrates the drone in prelaunch (FIG. 3) and post launch (FIG. 4) configurations.

FIG. 5A illustrates a camera capture of a prior art LOS system showing the center ‘crosshairs’ displaced from the object targeted by the targeting laser.

FIG. 5B illustrates a camera capture of the present system showing the back reflected second collimated light source centered on the object targeted.

### DETAILED DESCRIPTION

The present invention is of a drone delivery system that can be used to deliver a payload over short and long distances. Specifically, the present invention can be used to deliver a payload such as a package using a single LOS jump or multiple LOS jumps.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Line-of-sight delivery of a payload in either a GPS-poor environment or lack of GPS completely can be carried out using a human operator or an automated laser targeting system. While the latter system can be used to deliver a payload using a self-guiding aerial vehicle, small misalignments between the launcher and vehicle can introduce targeting errors that increase with an increase in the delivery distance thereby rendering such a system useless over relatively long LOS distances.

To correct for such misalignments, the present inventors devised a system that utilizes a launch carrier having a sighting/targeting laser (red dot) and a second parallel laser that is reflected into the video camera sensor of the aerial vehicle forming a virtual red dot in the captured video. The ‘virtual red dot’ in the video captured by the aerial vehicle ‘paints’ the same object targeted by the ‘red dot’ of the sighting/targeting laser thus greatly enhancing the targeting capabilities of LOS delivery systems even in cases where the aerial vehicle is not correctly aligned with the launch carrier.

Thus, according to one aspect of the present invention there is provided a line of sight (LOS) delivery system. The system includes a carrier device (e.g., guiderail mounted on a tripod or a handheld device such as a rifle) for supporting and launching an aerial vehicle (e.g., on the guiderail of the tripod or barrel of a rifle). The carrier includes a first collimated light source (e.g., “Red Dot” weapon sight such as the Trijicon RMR® Type 2 Adjustable LED Reflex Sight (trijicon(dot)com/products/product-family/trijicon-rmr-RM06-RM07-RM09), a distance meter (e.g., a laser-based range finder such as LRF Micro (newcon-optik(dot)com/products/laser-rangefinders/lrfmicro/) and a second collimated light source (e.g., laser) for outputting a beam substantially parallel to a targeting beam projected by the “Red Dot” weapon sight. The first and second collimated light sources output first and second collimated beams (respectively).

The second collimated light source can be an LT110B-P (thorlabs (dot)com/newgrouppage9(dot)cfm?objectgroup_ID=1379) and is mounted parallel (with a deviation from parallel that is derived from the distance and accuracy required and can be, for example, about 0.1 milliradians or less for a distance to target of about 0.1-0.5 km) to the first collimated light source and the distance meter. The first collimated light source, the second collimated light source and the range finder can be mounted on tracks and can be adjusted fore-aft, up-down and pitch forward-back via a screw mechanism.

The aerial vehicle can be any vehicle capable of controlled flight (glide or powered flight) and can include a fixed or deployable wing and/or lift rotors (e.g., drone). The aerial vehicle can include a power unit a combustion engine or an electrical motor powering a propellor or rotor or a rocket engine. A non-powered vehicle can be launched from a catapult mounted on the carrier and can glide to target or released at a parabolic trajectory.

The aerial vehicle can carry any payload of any size and weight. The payload can be a package deliverable to the target or releasable above the target or the payload can be an explosive (warhead) triggered at or near the target.

The aerial vehicle can include a camera for acquiring an image including that of the object targeted by the first collimated light source (‘Red Dot’ Weapon sight) and an optical assembly for reflecting the second collimated light source into the image to form a virtual light dot (virtual red dot) on the object captured on the image sensor of the camera. The optical assembly can include one or more prisms, such as Penta type prism, and/or 90 degree prism or any other type of prism, and mirror for directing the beam from the second collimated light source onto the camera sensor (CMOS or CCD). The carrier can include an optical component (prism) for directing the laser beam of the second collimated light source into the optical assembly of the aerial vehicle.

The aerial vehicle can also include a processing unit for processing the video information acquired by the camera (including the ‘virtual red dot’) and for controlling a flight of the aerial vehicle based either on a location of the ‘virtual red dot’ with respect to the object in the image as well as by locking a video tracker onto the object illuminated by the virtual “Red Dot”. Once the aerial vehicle is launched the object illuminated by the ‘virtual red dot’ on the image sensor is tracked and maintained within the object picture even if the second collimated beam ceases to illuminate the targeted object (launch and forget).

The aerial vehicle can also include a gyroscope, accelerometer, air speed indicator and related circuitry that can provide the processing unit with additional information that can be used to control the flight path of the aerial vehicle.

The flight path of the aerial vehicle can be along a linear or curved path or any path suitable for delivery. The processing unit can include additional software that can identify objects of interest in the captured video data that can intercept the aerial vehicle or block the flight path. The processed data can be used to alter the flight path of the aerial vehicle in order to avoid collision with such objects.

The present system can be set up to deliver a single payload over a single LOS path or to combine several LOS deliveries of a payload into a longer and non-line of sight delivery. In the latter case, several carriers can be set up at LOS distances from each other and used with one or more aerial vehicles to deliver a single payload. The payload can be transferred (manually or automatically) from one vehicle to another or a single vehicle can be launched from a carrier to a second carrier (where it is manually or automatically captured and loaded) and relaunched to a second target.

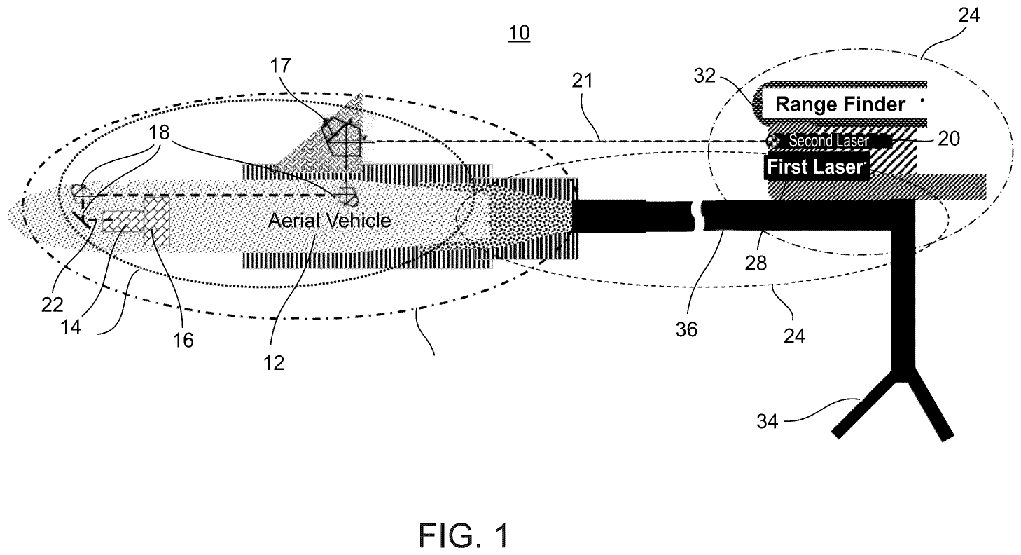

One embodiment of the present system which is referred to herein as system 10 is illustrated in FIGS. 1-4.

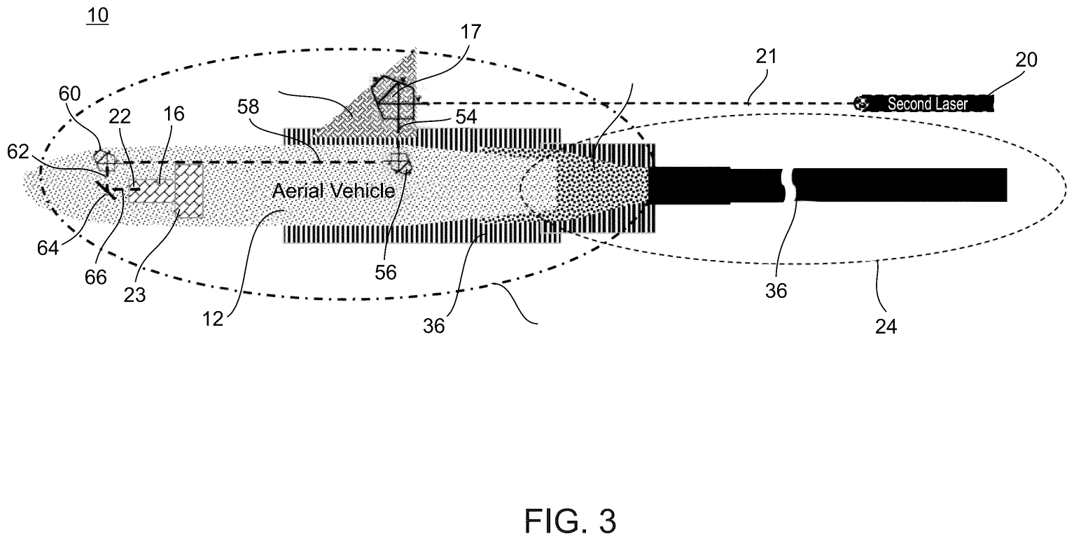

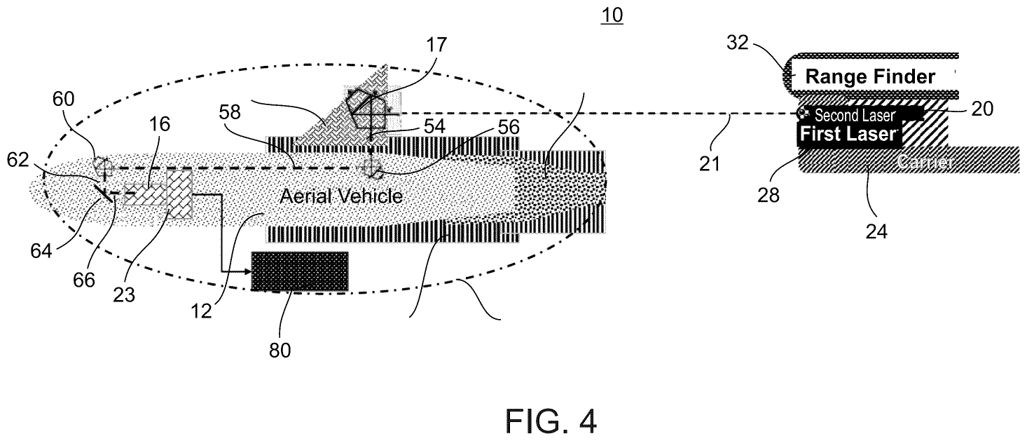

FIG. 1 schematically illustrates system 10 with aerial vehicle 12 mounted on a carrier 24. Aerial vehicle 12 carries a target tracking module 14 that includes a camera 16 and an optical assembly 18 that directs second collimated light source 20 into a lens 22 of camera 16. Optical component 17 forms a part of carrier 24 but functions in directing second collimated light source 20 into optical assembly 18 of aerial vehicle 12. The target tracking module is described in greater detail below with respect to FIGS. 3 and 4. Aerial vehicle 12 is mounted on a carrier 24 that includes a first collimated light source 28 (e.g., first laser) for painting the target, a second collimated light source 20 (e.g., second laser) for painting the target as captured in camera sighting unit 16 and a range finder 32. Carrier 24 can include a tripod 34 supporting a guide rail 36 onto which aerial vehicle 12 is mounted.

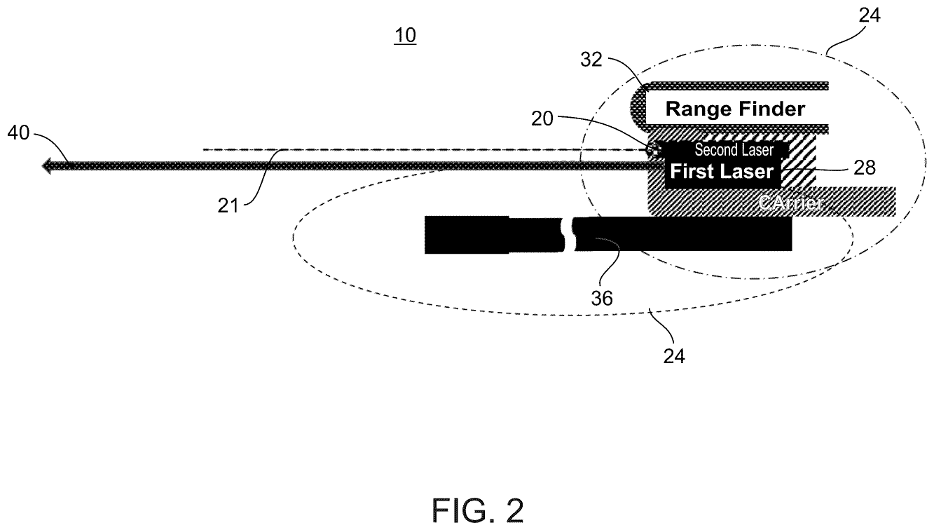

FIG. 2 schematically illustrates the targeting components of carrier 24. First collimated light source 28 projects a collimated beam 40 in the direction designated by the arrow that can form a typical “red dot” on object. Carrier 24 can also include a range finder 42 and a second collimated light source 20 (e.g., collimated laser diode illuminator) producing a collimated beam indicated by 21.

Range finder 42, first collimated light source 28 and second collimated light source 20 are mounted on carrier 24 such that beams produced thereby are substantially parallel to each other (with an offset from parallel of typically no more than 0.1 milliradians. The offset depends on the accuracy required to launch the aerial vehicle divided by the launching distance and is defined based on this consideration. If need be, the beams can be aligned to parallel using a screw adjustment mechanism such that range finder 42 and second collimated light source 20 are parallel to each other and first collimated light source 28.

FIG. 3 illustrates aerial vehicle 12 and its target tracking module 14 mounted on guide rail 36 (e.g. rifle barrel). Second collimated light source 20 of carrier 24 produces a collimated light beam 21 parallel to that produced by first collimated light source 28 (which physically or virtually paints the target location). Light beam 21 impinges on optical component 17 (e.g., a prism, such as a Penta prism) that folds the beam at 90 degrees regardless of the mounting lateral or angular mounting accuracy of aerial Vehicle 12 relative to the guide rail 36 of carrier 24. Optical component 17 ensures that light beam 21 is refracted perpendicularly to form beam 54 that is directed into optical assembly 18 of aerial vehicle 12. Optical assembly 18 includes a prism 56 (e.g., a prism, such as a Penta prism) that folds beam 54 at 90 degrees regardless of the mounting lateral or angular mounting accuracy to form folded beam 58 which is perpendicular to beam 54. Beam 58 impinges on prism 60 (e.g., a prism, such as a Penta prism) that folds beam 58 at 90 degrees regardless of the mounting lateral or angular mounting accuracy to form a perpendicular beam 62. If Penta prisms are used in 17 and 56, such prisms do not need to be perfectly aligned to one another due to the nature of Penta Prisms. Thus, regardless of assembly accuracy, beams 50 and 58 will always be perpendicular to one other.

Optical assembly 18 also includes a 90 degrees folding mirror 64 and a Hi-Res camera 16 and lens 19. Mirror 64 directs beam 66 into camera lens 22 to superimpose a red dot on the sight picture captured by sensor 23 of camera 16.

Since beam 21 of second collimated light source 20 is parallel to beam 40 of first collimated light source 28 and both are parallel to range finder 42, optical component 17 of carrier 24 and optical assembly 18 of aerial vehicle 12 produce a beam dot (‘virtual red dot’) on the image sensor of camera 16 that represents the exact location on the target painted by beam 40 of first collimated light source 28 regardless of the degree of alignment between aerial vehicle 12 and carrier 24. In other words, even if aerial vehicle 12 is not mounted accurately on guide rail 36 of carrier 24, sighting will be correct. In case aerial vehicle 12 is not co-linear with guide rail 36 the central pixel of camera 16 (crosshair middle) will not necessarily be aligned with the painted target, however, the dot projected onto the camera sensor from beam 21 will be aligned with the painted target.

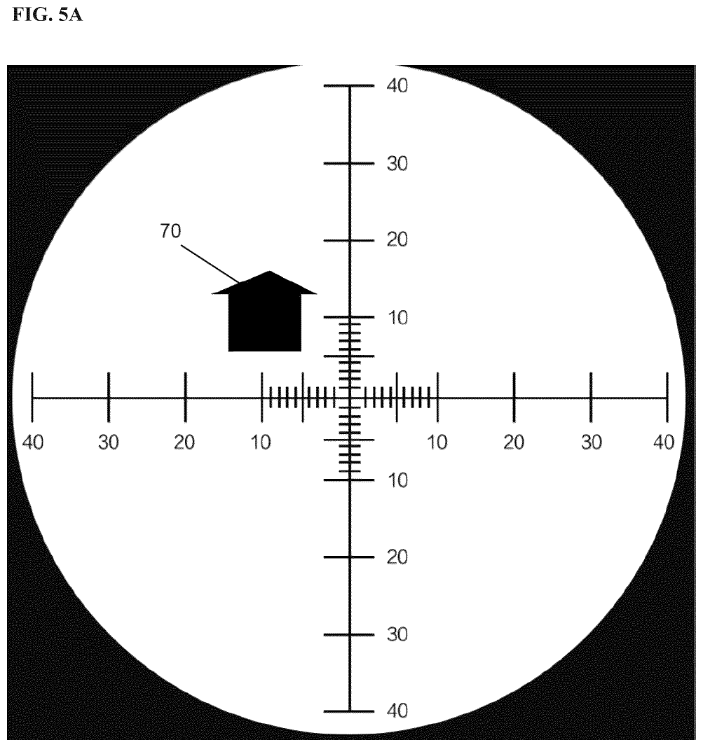

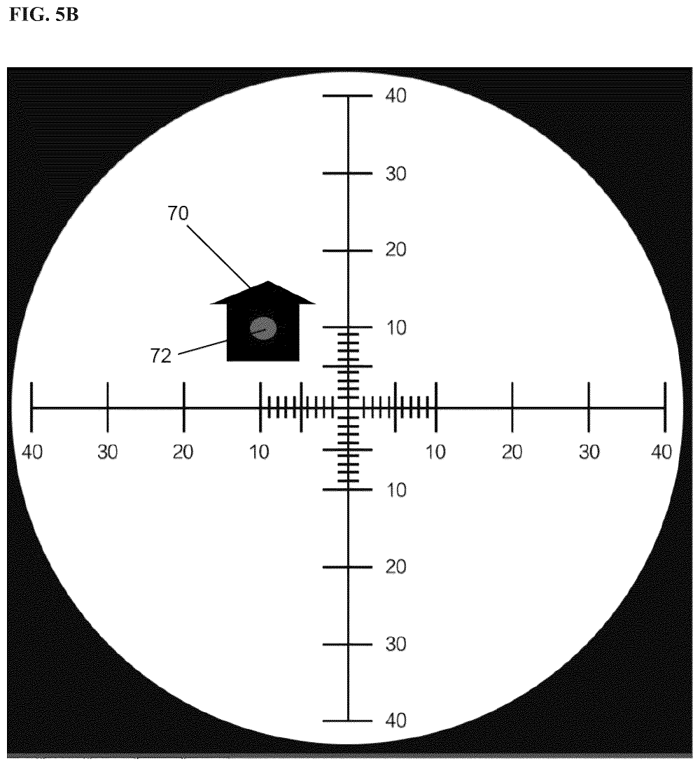

FIGS. 5A-B illustrate this advantage of the present system. As is shown in FIG. 5A, when a delivery vehicle and a carrier are misaligned in prior art systems, a sighted target 70 (painted with red dot sights) does not align with the camera center (‘cross hairs’) and thus aerial vehicle 12 will fly using the cross hair center as a targeting guide and would thus miss the target. While such misalignment can also occur with system 10 (FIG. 5B), the use of a second collimated light source 20 (e.g., second laser) ensures that target 70 is painted with a ‘virtual ’ (in-picture) red dot 72 thereby aligning the flight path of aerial vehicle 12 with the target.

FIG. 4 illustrates the navigation component of aerial vehicle 12 that processes the targeting picture from camera 16 and onboard aerial vehicle information to guide the aerial vehicle to the target location. The navigation component includes a video tracker unit 80 having a processing unit and software for identifying the target painted by the virtual red dot and for tracking the virtual red dot position with respect to the target following launch and during flight. Video tracker unit 80 receives at least the input from camera 16, the distance as measured by the LRF and on board gyroscope and accelerometer, processes the information using an on-board processing unit and sends (wired or wireless) commands to the control surfaces (rudder, elevator, ailerons etc.) and engine of aerial vehicle 12 in order to maintain aerial vehicle 12 on target during flight. For example, if the position of the virtual red dot drifts sideways from a center of the object (captured in camera sensor) then video tracker unit 80 send a control signal to a rudder and/or ailerons (of a fixed wing vehicle 12) or a lift rotor (of a drone) to adjust the flight path and bring the virtual red dot back into the center

Video trackers such as the 4000-OEM (sightlineapplications(dot)com/product/4000-oem/) can be used in the present invention.

Aerial vehicle can be any self-powered or non-self powered vehicle capable of sustaining flight over LOS distances (several Kilometers) while carrying a payload.

As used herein the term “about” refers to +10%.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. In addition, any priority document(s) of this application is/are hereby incorporated herein by reference in its/their entirety.

1. A line of sight (LOS) delivery system comprising:
(a) a carrier device including:
(i) a first collimated light source for targeting an object;
(ii) a distance meter; and
(iii) a second collimated light source for outputting a beam substantially parallel to a targeting beam of said first collimated light source; and
(b) an aerial vehicle mounted on said carrier device, said aerial vehicle including:
(i) a camera for acquiring an image including said object targeted by said first collimated light source;
(ii) an optical assembly for reflecting said second collimated light source into said image to form a light dot on said object; and
(iii) a processing unit for controlling a flight of said aerial vehicle based on a location of said light dot with respect to said object in said image.

2. The system of claim 1, wherein said carrier includes a guide rail for launching said aerial vehicle.

3. The system of claim 1, wherein said aerial vehicle is a fixed wing vehicle.

4. The system of claim 3, wherein said fixed wing vehicle deploys a wing following launching from said carrier.

5. The system of claim 1, wherein a maximum deviation from parallel between said first collimated light source and said second collimated light source is 0.1 milliradians.

6. The system of claim 1, wherein said processing unit establishes a flight path for said aerial vehicle based on a distance to object and the environment.

7. The system of claim 1, wherein said aerial vehicle includes a payload.

8. The system of claim 7, wherein said payload is a package.

9. The system of claim 7, wherein said payload is a warhead.

10. A method of line of sight (LOS) delivery of a payload comprising:
(a) targeting an object using a first collimated light beam;
(b) determining a distance to said target; and
(c) outputting a second collimated light beam substantially parallel to said first collimated light source; and
(b) launching an aerial vehicle, said aerial vehicle including:
(i) a camera for acquiring an image including said object targeted by said first collimated light beam;
(ii) optics for reflecting said second collimated light beam into said image to form a light dot on said object; and
(iii) a processing unit for controlling a flight of said aerial vehicle based on a location of said light dot with respect to said object in said image;
(d) navigating said aerial vehicle using said processing unit thereby delivering the payload to said target.

11. The method of claim 10, further comprising repeating steps (a)-(d) to a second object.

12. The method of claim 10, wherein said aerial vehicle is launched from a carrier including a guide rail.

13. The method of claim 10, wherein said aerial vehicle is a fixed wing vehicle.

14. The method of claim 13, wherein said fixed wing vehicle deploys a wing following launching from said carrier.

15. The method of claim 10, wherein a maximum deviation from parallel between said first collimated light beam and said second collimated light beam is 0.1 milliradians.

16. The method of claim 10, wherein said processing unit establishes a flight path for said aerial vehicle based on said distance to object and the environment.

17. The method of claim 10, wherein said aerial vehicle includes a payload.

18. The method of claim 17, wherein said payload is a package.

19. The method of claim 17, wherein said payload is a warhead.

20-24. (canceled)
